(19) United States
(12) Patent Application Publication
(10) Pub. No.: US 2017/0293978 A1
(43) Pub. Date: Oct. 12, 2017

(54) CUSTOMIZABLE INFORMATION SYSTEM AND RELATED METHOD

(71) Applicant: SOUNDER TECHNOLOGY INC., New Taipei City (TW)

(72) Inventor: CHIEN-CHENG LEE, New Taipei City (TW)

(21) Appl. No.: 15/092,622

(22) Filed: Apr. 7, 2016

(51) Int. Cl. G06Q 40/06; G06F 3/0482; G06F 17/24; G06F 3/0483; H04L 29/06; G06F 17/30

(52) U.S. Cl. CPC G06Q 40/06; H04L 67/42; H04L 63/101; G06F 17/30554; G06F 17/248; G06F 3/0483; G06F 3/0482

(57) ABSTRACT

A customizable information system and a related method are disclosed. The system contains a server host and, inside the server host, a database, a development module, a design module, and an integration module. Through the design module, a user arranges a template and functional blocks, and creates a number of pages of information. The user then combes a number of pages of information into a volume of information through the integration module so as to achieve the customization of various data and functions for convenient access and clear viewing.

### BACKGROUND OF THE INVENTION

### (a) Technical Field of the Invention

The present invention is generally related to information systems, and more particular to a customizable information system and a related method.

### (b) Description of the Prior Art

There are various types of financial devices and systems collecting data from different sources and using different analysis theories to provide information for investment decision.

Conventionally, these financial devices and systems have a fixed set of functions and data sources, and cannot completely satisfy the needs of different investors. The investors therefore have to switch back and forth constantly to look for required data, and these data cannot be manifested simultaneously for comparison and analysis, causing investors a lot of trouble and difficulty.

### SUMMARY OF THE INVENTION

The objective of the present invention therefore is to provide a customizable system and a related method so that various data and functions are customized and integrated together for convenient access and clear viewing.

To achieve the objective, the customizable information system contains a server host and, inside the server host, a database for storing messages, a development module having at least a template and a number of functional blocks, each linking at least a message, a design module for arranging the template and functional block and creating a number of pages of information, and an integration module combining pages of information into a volume of information for user access. As to the related method, multiple messages are stored in the database, and a template and a number of functional blocks for linking and reflecting the messages are created. Then, a template and some functional blocks are selected, arranged, and adjusted through the design module to create a page of information Finally, a number of pages of information are selected and ordered into a volume. Subsequently, different users can link and access these volumes of information from their respective electronic devices to achieve convenient access and clear viewing. The prior art's problems such as inflexible set of data and functions and usage inconvenience and difficulty are as such resolved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a customizable information system according to an embodiment of the present invention.

FIG. 2 is a flow diagram showing the major steps of a method of customizing information.

FIG. 3 is a schematic diagram showing the selection of a functional block of the customizable information system of FIG. 1.

FIG. 4 is a schematic diagram showing the generation of a page of information of the customizable information system of FIG. 1.

FIG. 5 is a schematic diagram showing the organization of pages of information of the customizable information system of FIG. 1.

FIG. 6 is a schematic diagram showing the integration of pages of information into a volume of information of the customizable information system of FIG. 1.

FIG. 7 is a schematic diagram showing a number of volumes of information of the customizable information system of FIG. 1.

FIG. 8 is a schematic diagram showing the access of volumes of information from electronic devices of the customizable information system of FIG. 1.

FIG. 9 is a schematic diagram showing the procurement of access to a volume of information of the customizable information system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

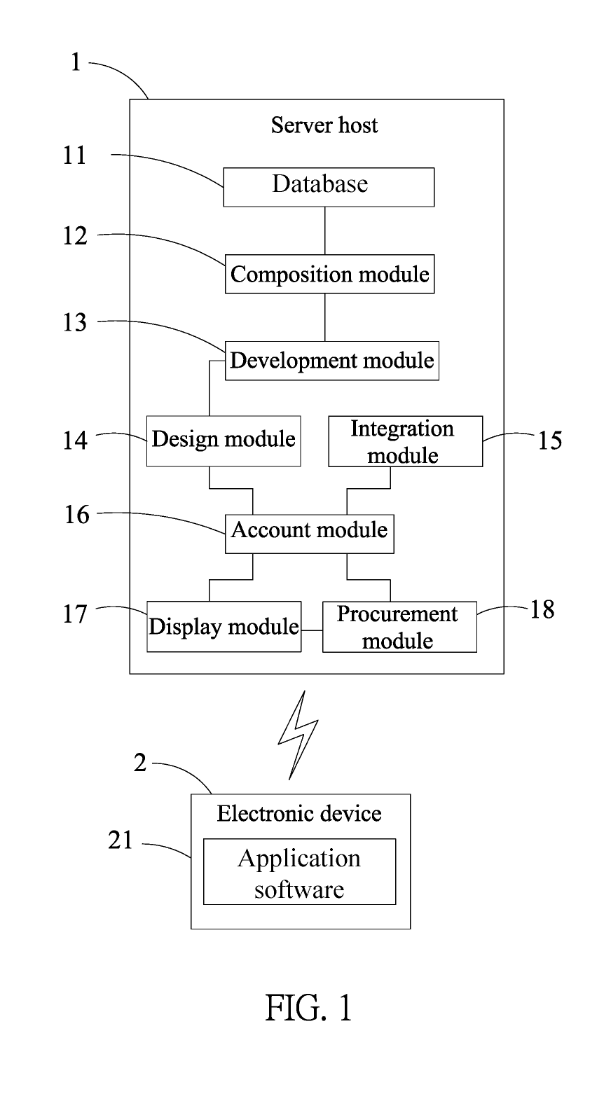

As shown in FIG. 1, a customizable information system according to an embodiment of the present invention contains a server host 1, a database 11, a composition module 12, a development module 13, a design module 14, an integration module 15, at least an account module 16, at least a display module 17, at least a procurement module 18, at least an electronic device 2, and at least an application software 21. The database 11 is configured in the server host 1 and stores a number of messages. In the present embodiment, messages of financial information are used as example. The development module 13 is also configured in the server host 1, and contains at least a template A (not shown) and a number of functional blocks B (not shown). In the present embodiment, the template A and functional blocks B are for presenting financial information as an example. The template A and the function blocks B are compliant with one of the operating systems Android, iPhone OS (iOS), and Microsoft Windows. The template A contains at least one of text, image, graph, chart, report, and menu.

The composition module 12 is configured in the server host 1 and data-linked with the development module 13. The composition module 12 is for creating and editing the template A and the various functional blocks B and storing the built template and functional blocks A and B in the development module 13.

The account module 16 is configured in the server host 1 and corresponding to at least a user information. The design module 14 is configured in the server host 1 and data-linked with the account module 16 and the development module 13. The integration module 15 is configured in the server host 1 and data-liked with the account module 16.

The display module 17 is configured in the server host 1 and data-linked with the account module 16. Each procurement module 18 is also configured in the server host 1 and data-linked with the account module 16 and the display module 17.

Each electronic device 2 can be one of a cellular phone, a tablet, and a computer. Each application software 21 is configured in one of the electronic devices 2, and data-linked with the server host 1 and its account module 16.

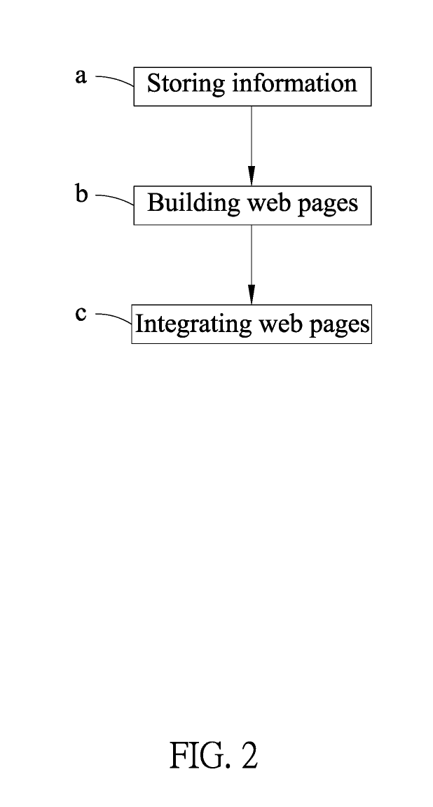

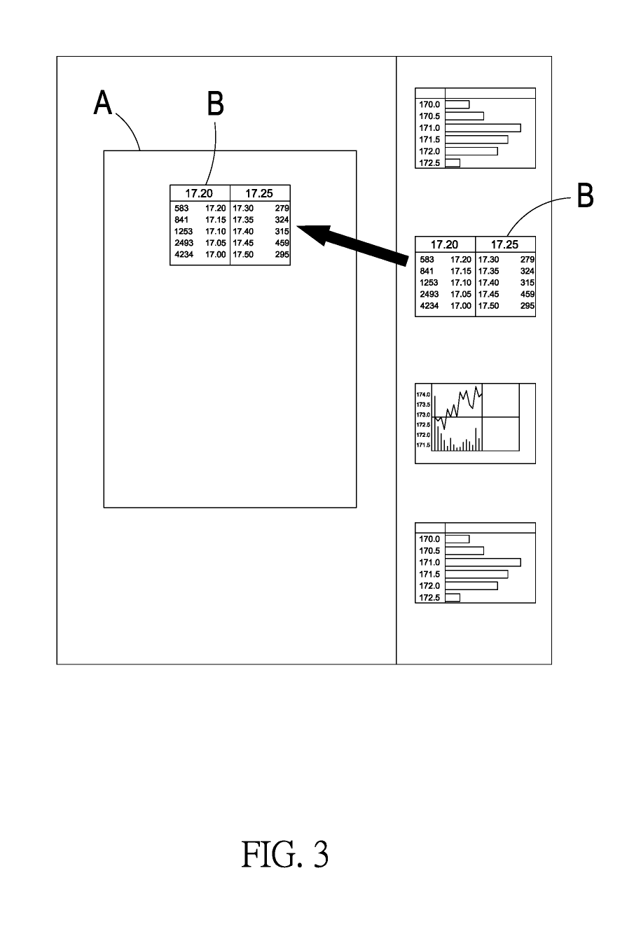

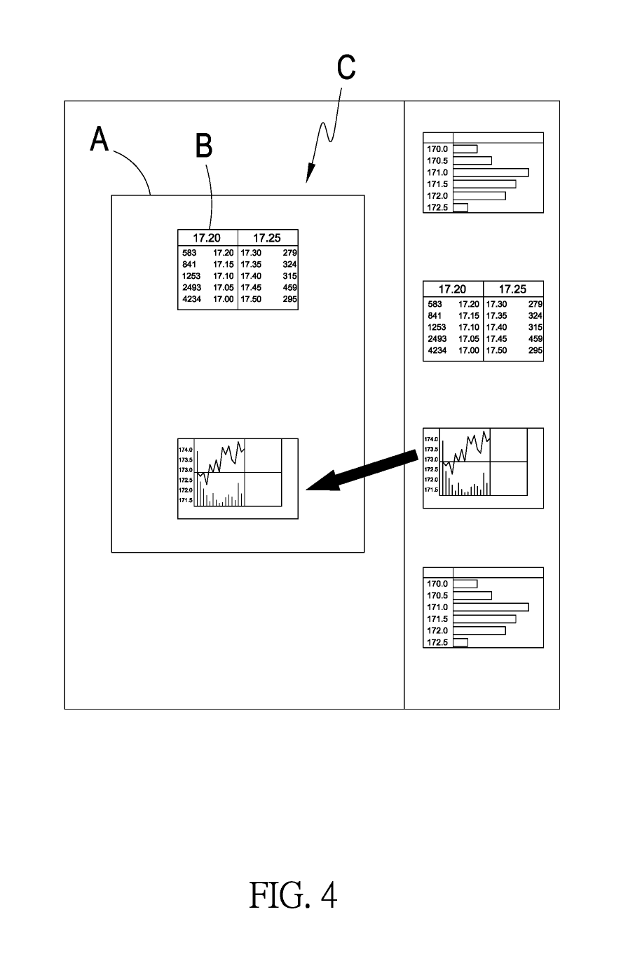

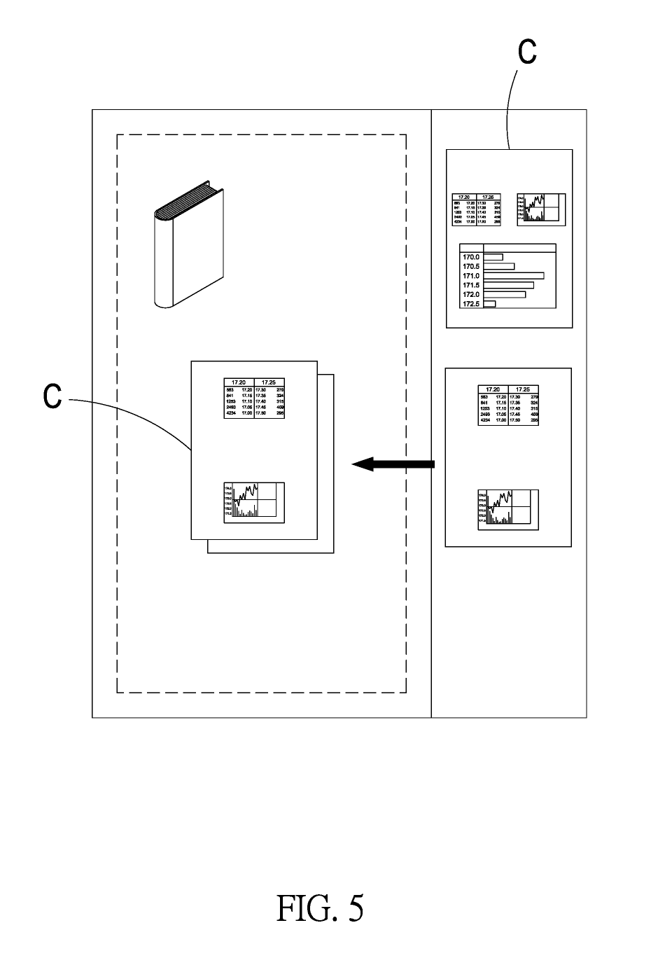

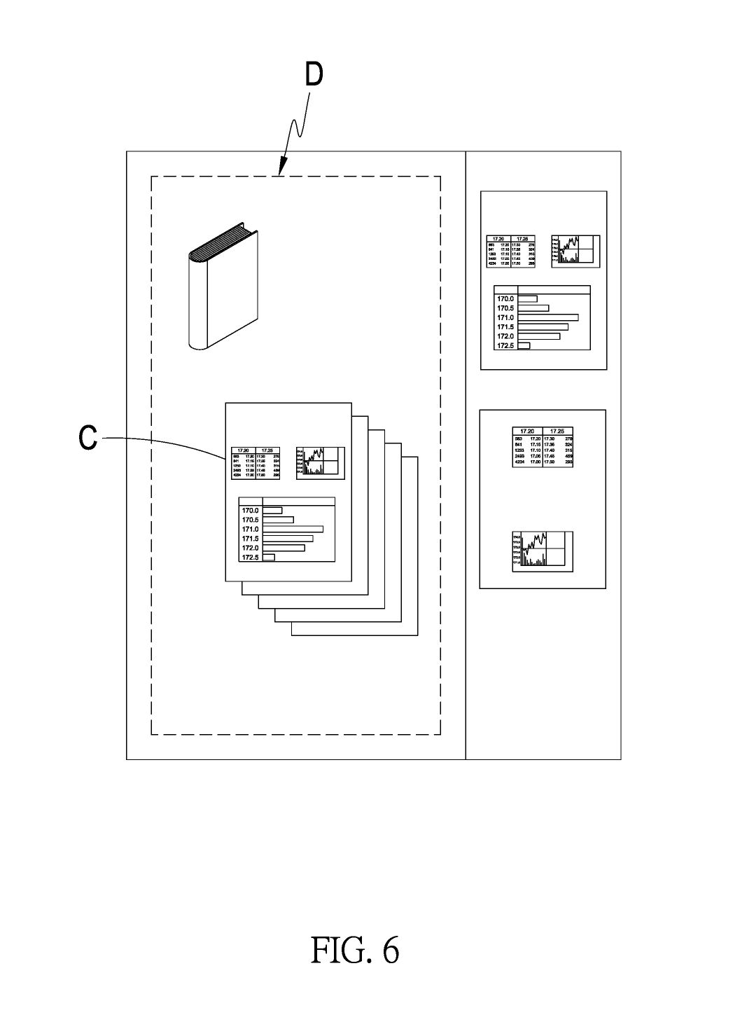

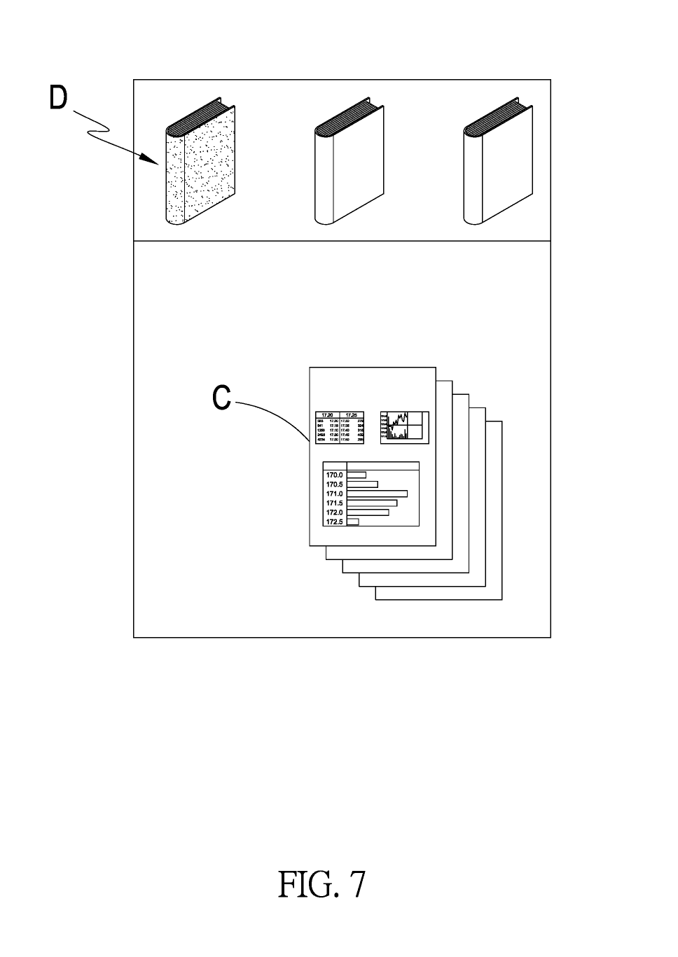

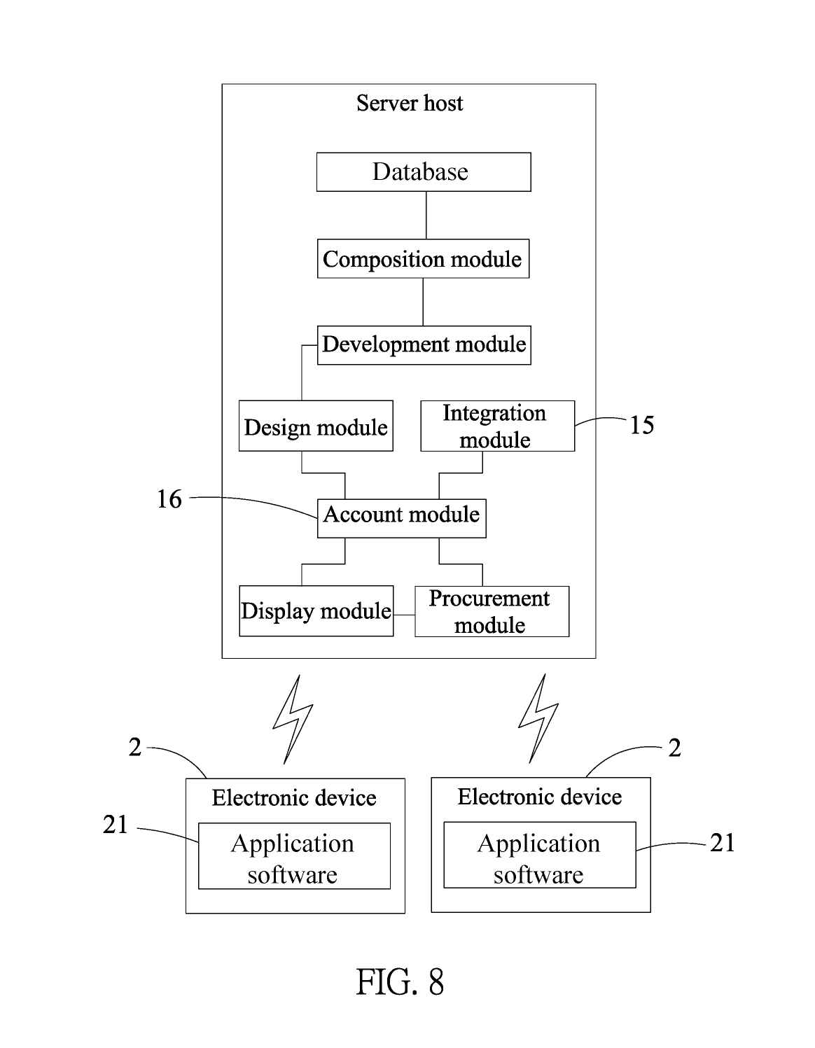

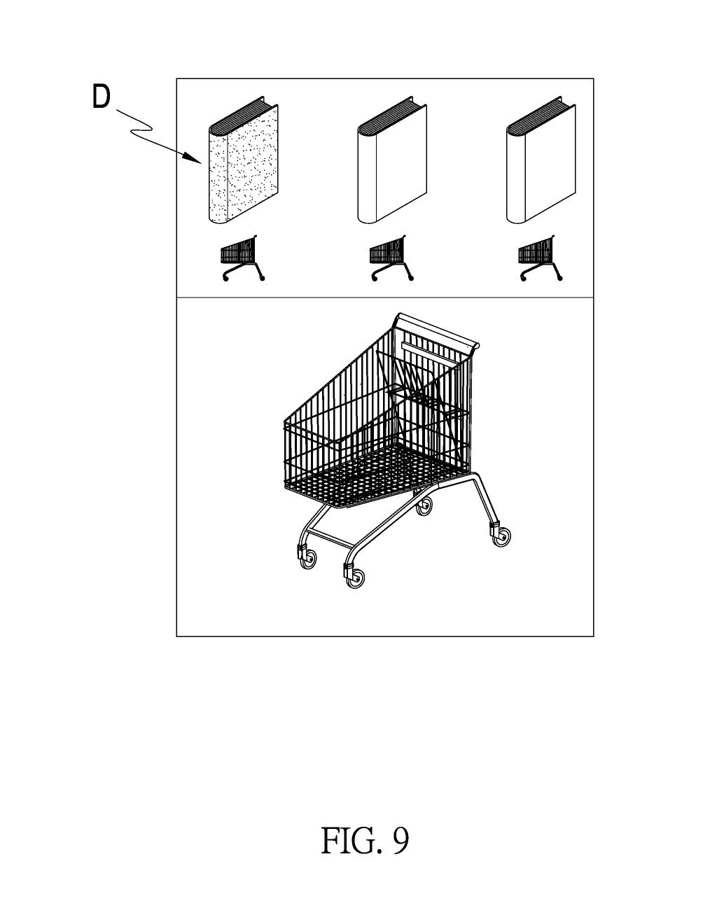

As shown in FIGS. 1 to 9, the operation of the customizable information system contains three major steps: storing information (step A), building pages of information (step B), and integrating pages of information (step C).

In step A, multiple messages such as company profits and losses, stock prices, and transaction volumes are stored in the database 11, and a template A and a number of functional blocks B for reflecting company profits and losses, stock prices, transaction volumes, and the various charts and tables are created by a programmer through the composition module 12 and stored in the development module 13. In step B, the application software of an electronic device 2 is operated by a user to link with the server host 1, the account module 16, and the design module 14. Then, a template A and some functional blocks B are selected from the development module 13 and the functional blocks B are arranged on the template A through the design module 14 by the user. The design module 14 creates a page of information C in accordance with the template A and the functional blocks B, and stores the page of information C in the account module 16 Finally, in step C, the integration module 15 is operated by the user to select and order a number of pages of information C into a volume of information D. The volume of information D is then stored in the account module 16. Subsequently, different users can link and access these volumes of information D from their respective electronic devices 2.

More specifically, specific functional blocks B (such as company profits and losses, stock prices, transaction volumes, and the various charts and tables) are picked and arranged on the template A. Their positions and sizes are adjusted to fit user requirement. The result (the composed template A and the functional blocks B) is used to create a page of information C. A number of pages of information C are picked and organized into a volume of information D for user subsequent access. As such, various information and functions are customized and integrated together for simplified and convenient usage, and for clear and speedy viewing and comparison.

For users, they can choose an appropriate electronic device 2 to access an appropriate volume of information D selected, arranged, and ordered according to the user demand. Depending on the needs, different volumes of information D can be selected and accessed.

In addition, a specific volume of information D can be selected and transmitted to a display module 17 for presentation to other people. For a person interested in a specific volume of information D, he/she can link the procurement module 18 through the account module 16 to purchase a privilege of accessing the volume of information D. The purchaser then can access the volume of information D from his/her electronic device 2 and the installed application software 21.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A customizable information system comprising:
a server host;
a database inside the server host for storing messages;
a development module inside the server host comprising at least a template and a plurality of functional blocks where each functional block links at least a message;
a design module inside the server host for arranging the template and functional block and creating a plurality of pages of information; and
an integration module inside the server host combining a plurality of pages of information into a volume of information for user access.

2. The customizable information system according to claim 1, further comprising an electronic device and an application software on the electronic device for linking the server host.

3. The customizable information system according to claim 1, further comprising an account module storing at least a user information.

4. The customizable information system according to claim 1, further comprising a display module and a procurement module where the display module presents the volume of information and the procurement module provides access privilege to a volume of information to a purchaser.

5. The customizable information system according to claim 1, further comprising a composition module for editing the template and the functional blocks and storing the built template and functional blocks in the development module.

6. The customizable information system according to claim 1, wherein the messages comprise messages of financial information.

7. A method of customizing information comprising the steps of:
storing a plurality of messages in a database of, and storing at least a template and a plurality of functional blocks in a development module of a server host where each functional block links at least a message;
providing a plurality of pages of information by selecting and arranging the template and the functional blocks through a design module of the server host; and
providing a volume of information by selecting and ordering a plurality of pages of information for users to link and access.

8. The method of customizing information according to claim 7, wherein the server host is linked and accessed by a user through an electronic device and an application software on the electronic device.

9. The method of customizing information according to claim 7, wherein a user has a corresponding user information in an account module of the server host.

10. The method of customizing information according to claim 7, where the volume of information is presented by a display module of the server host; and access privilege to a volume of information is obtained through a procurement module of the server host.

11. The method of customizing information according to claim 7, wherein the template and the functional blocks are created and edited through a composition module of the server host.

12. The method of customizing information according to claim 7, wherein the messages comprise messages of financial information.
